(19) United States
(12) Patent Application Publication
(10) Pub. No.: US 2008/0133695 A1
(43) Pub. Date: Jun. 5, 2008

(54) Information processing system and backing up data method

(75) Inventors: Kazuhiro Suzuki, Kanagawa (JP); Takeshi Kamimura, Kanagawa (JP); Hisayoshi Mori, Kanagawa (JP); Tsutomu Hamada, Kanagawa (JP); Shinobu Ozeki, Kanagawa (JP); Kenichi Kobayashi, Kanagawa (JP); Jun Kitamura, Kanagawa (JP); Junji Okada, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/891,572

(22) Filed: Aug. 10, 2007

(30) Foreign Application Priority Data
Dec. 1, 2006 (JP) 2006-325703

(51) Int. Cl. G06F 15/167

(52) U.S. Cl. 709/216

(57) ABSTRACT

An information processing system includes a first server, a second server and a memory unit. The first server accumulates the data which is input through a network. The second server is connected to the network and it is physically disposed at a predetermined distance from the first server, and it backs up the data from the first server. The memory unit is connected to the network and it is connected to the first server in the vicinity of the first server through a dedicated line, and it temporarily stores backup data to be sent to the second server.

### CROSS-REFERENCE TO RELATED APPLICATIONS

This application is based on and claims priority under 35 USC 119 from Japanese Patent Application No. 2006-325703 filed Dec. 1, 2006.

### BACKGROUND

1. Technical Field

This invention relates to an information processing system and a method of backing up data.

2. Related Art

The conventional techniques for improving the reliability of the data stored in a magnetic disk or the like include RAID (Redundant Arrays for Inexpensive Disks) or the like. Further, to prevent the data loss due to an accident such as a fire or an earthquake, a method is available for backing up the data with a copy thereof at a remote site. Specifically, an input terminal device is connected to a storage system including a main memory system and an auxiliary memory system. The servers of the main memory system and the auxiliary memory system are connected to each other through a LAN (Local Area Network) or a WAN (Wide Area Network) as well as the input terminal device. Therefore, the data of the server of the main memory system are copied to the server of the auxiliary memory system through the LAN or the WAN.

However, when a change occurs in the storage server of the server of the main memory system, the exclusive state of the server of the main memory system may be sustained or cause the clients to wait. Further, it is physically difficult and expensive to connect the server of the main memory system and the server of the auxiliary memory system at a remote site by a dedicated line.

### SUMMARY

According to an aspect of the invention, there is provided an information processing system including: a first server that accumulates data that is input through a network; a second server that is connected to the network, that is physically disposed at a predetermined distance from the first server and that backs up the data from the first server; and a memory unit that is connected to the network, that is connected to the first server through a dedicated line in the vicinity of the first server and that temporarily stores backup data to be sent to the second server.

### BRIEF DESCRIPTION OF THE DRAWINGS

Exemplary embodiments of the present invention will be described in detail based on the following figures, wherein:

FIG. 1 is a diagram (block diagram) showing a general configuration of an information processing system according to a first exemplary embodiment of the invention;

FIG. 2 is a flowchart for a first mirroring control flow in the information processing system according to the first exemplary embodiment of the invention;

FIG. 3 is a diagram (block diagram) showing a general configuration of an information processing system according to a second exemplary embodiment of the invention; and

FIG. 4 is a flowchart for a second mirroring control flow in an information processing system according to the second exemplary embodiment of the invention.

### DETAILED DESCRIPTION

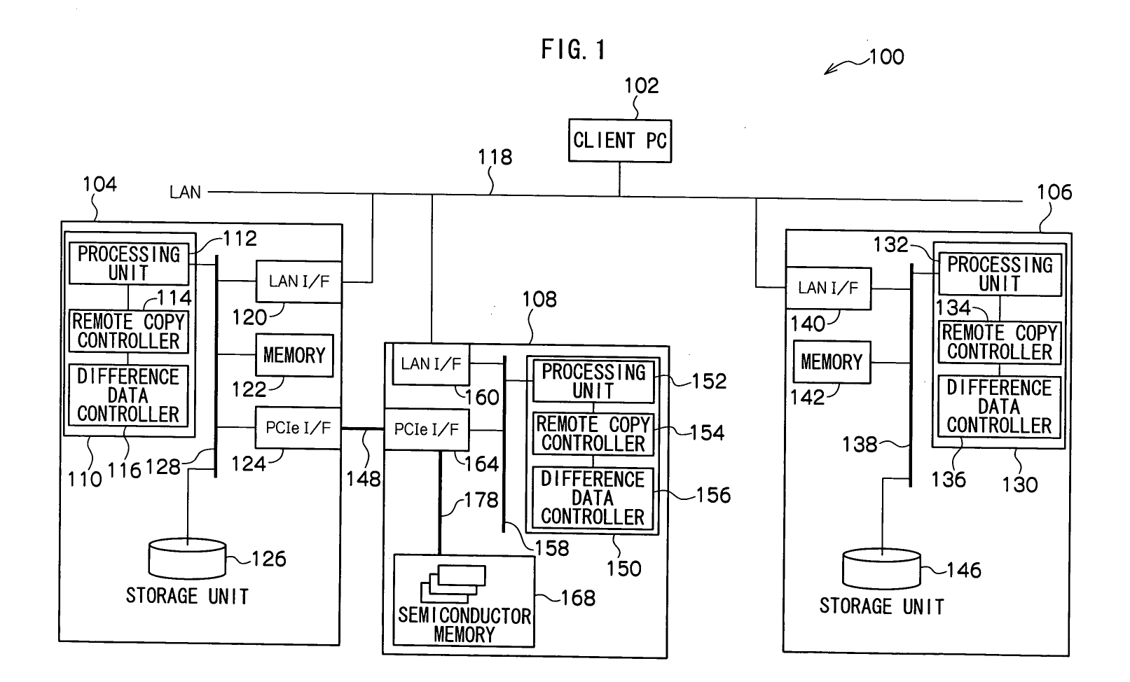

FIG. 1 is a diagram (block diagram) showing a general configuration of an information processing system according to a first exemplary embodiment of the invention.

A first information processing system 100 includes a client PC (hereinafter referred to as the input terminal device) 102, a first server 104, a second server 106 and a memory unit 108.

The input terminal device 102, the first server 104, the second server 106 and the memory unit 108 are connected through a LAN (or a WAN) 118. The first server 104 and the memory unit 108 are connected by a dedicated line 148 used for high-speed channel.

The input terminal device 102 is a terminal such as a personal computer to send the data to the first server 104. The first server 104, called a local server, is a basic file server. The memory unit 108, called the semiconductor memory device, has a semiconductor memory 168 (having 16 gigabytes) built therein to store the data. The second server 106, called the remote server, is disposed at a position distant (remote site) from the first server 104 to copy (mirror) the data of the first server 104.

The first server 104 includes a process controller 110, a LAN, an I/F 120, a memory 122, a PCIe I/F 124 and a storage unit 126, that are connected to each other through a first bus 128. Although the devices and the controller are connected through the first bus 128 for the saked convenience above, the first bus 128 indicates the data flow. Specifically, the first bus 128 includes a multiplicity of channels, and transmission lines (buses) such as a device acting as an arbiter and a semiconductor device for controlling the signal flow of the controller.

The process controller 110 includes a processing unit 112, a remote copy controller 114 and a difference data controller 116.

The processing unit 112 centrally controls the remote copy controller 114 and a difference data controller 116 thereby to control transmissing/receiving the data of the first server 104. The remote copy controller 114 performs the control operation for copying the data. Specifically, the remote copy controller 114 transmits an instruction to copy the data to the memory unit 108 and the storage unit 126 of the first server 104. When the data accumulated in the storage unit 126 is changed, updated or added, the difference data controller 116 transmits an instruction to control the difference data to the processing unit 112 through the remote copy controller 114. Specifically, when the data accumulated in the storage unit 126 is changed, updated or added by the data sent from the input terminal device 102, the difference data controller 116 outputs the information or an instruction indicating the manner in which the data is changed, updated or added based on the difference data, to the processing unit 112 through the remote copy controller 114. Further, an instruction to transmit/receive additional information indicating that the difference data is involved is output to the processing unit 112 through the remote copy controller 114.

The LAN I/F 120 is an interface mediating the data transmission/receiving between the LAN 118 and the first server 104.

The memory 122 has stored the data from the LAN 118 through the LAN I/F 120. Further, the memory 122 constitutes a working area for data processing in the process controller 110.

The PCIe I/F 124 is an interface with the memory unit 108 and mediates to send the data to the memory unit 108. The PCIe I/F 124 is an abbreviation of “PCI Express Interface” that is a high-speed serial transfer interface replacing the PCI bus.

The data from the input terminal device 102 or an external source are processed in the process controller 110 through the LAN 118 and accumulated in the storage unit 126. Specifically, the storage unit 126 is a device for storing the program and the data in the computer, and is such as a hard disk, a flexible disk, a MO (Magneto-Optical disk), a CD-R (Compact Disk Recordable) or a magnetic tap.

The second server 106 includes a process controller 130, a LAN I/F 140, a memory 142 and a storage unit 146 which are connected to each other through a second bus 138. Like the first bus 128, the second bus 138 is assumed to represent the flow of data for the saked convenience in FIG. 1, and includes many channels or transmission paths (bus) such as a device acting as an arbiter and a semiconductor device for controlling the signal flow.

The process controller 130 includes a processing unit 132, a remote copy controller 134 and a difference data controller 136.

The processing unit 132, the remote copy controller 134 and the difference data controller 136 of the process controller 130 have the same functions as the processing unit 112, the remote copy controller 114 and the difference data controller 116, respectively, of the first server 104.

Similarly, the LAN I/F 140, the memory 142 and the storage unit 146 have the same functions as the LAN I/F 120, the memory 122 and the storage unit 126, respectively, of the first server 104.

The memory unit 108 includes a process controller 150, a LAN I/F 160, a PCIe I/F 164 and a semiconductor memory 168 and are disposed in the vicinity of the first server 104.

The process controller 150, the LAN I/F 160 and the PCIe I/F 164 are connected through a PCI bus 158. The PCIe I/F 164 is connected to a semiconductor memory 168 through a dedicated serial I/F (called the third bus 178). The third bus 178 indicates the data flow and it is constituted of a channel or a transmission path (bus).

The processing unit 152, the remote copy controller 154 and the difference data controller 156 of the process controller 150 have the same functions as the processing units 112 and 132, the remote copy controllers 114 and 134 and the difference data controllers 116 and 136, respectively, of the process controller 110 of the first server 104 and the process controller 130 of the second server 106.

The process controller 110 of the first server 104 controls the operation of transmitting/receiving the data or the difference data to/from the storage unit 126 of the first server 104. The process controller 130 of the second server 106 controls the operation of transmitting/receiving the data or the difference data to/from the storage unit 146 of the second server 106. The process controller 150 controls the transmission/receiving of the data or the difference data to/from the semiconductor memory 168 and the deletion of the same data.

Similarly, the LAN I/F 160 and the PCIe I/F 164 have the same functions as the LAN I/F 120 and the PCIe I/F 124, respectively, of the first server 104.

The operation of this exemplary embodiment is explained below.

The data input from the input terminal device 102 is transferred to the first server 104 through the LAN 118. As an alternative, the data may be input from an external source other than the input terminal device 102 and transferred to the first server 104 through the LAN 118.

The data sent to the first server 104 is processed by the process controller 110 and the memory 122, and accumulated in the storage unit 126, while at the same time being copied to the semiconductor memory 168 of the memory unit 108 through the PCIe I/Fs 124, 164 and the dedicated line 148. The data are written in the semiconductor memory 168 of the memory unit 108 through the PCIe I/Fs 124, 164 and the dedicated line 148 at a higher rate than the rate at which the data are written in the storage unit 126 of the first server 104. Therefore, while the data of the storage unit 126 are updated, the data may be copied (mirrored) in real time to the semiconductor memory 168 of the memory unit 108. The server resources required for this job are sufficiently small in amount.

Specifically, after the data are accumulated in the storage unit 126, the remote copy controller 114 of the process controller 110 transmits an instruction to the processing unit 112 such that the data accumulated in the storage unit 126 are sent to the semiconductor device 108 through the dedicated line 148.

The processing unit 112 that has received the instruction transfers the data accumulated in the storage unit 126 to the semiconductor device 108 through the dedicated line 148. In the process, the data accumulated in the storage unit 126 are transferred to the memory unit 108 through the first bus 128, the PCIe I/F 124 and the dedicated line 148 capable of fast data transfer.

In the memory unit 108, the data transferred to the memory unit 108 from the first server 104 are temporarily stored in the semiconductor memory 168 through the PCIe I/F 164 and the third bus 178 by the processing unit 152 of the process controller 150.

When the capacity of the data to be transferred from the storage unit 126 exceeds the capacity of the semiconductor memory 168, the process is executed as described below. Specifically, the difference data controller 116 of the process controller 110 controls the remote copy controller 114, the remote copy controller 114 controls the processing unit 112, only the difference data which is updated after the previous updating session is temporarily stored in the semiconductor memory 168 of the memory unit 108. In the process, the difference data constituting the update data transferred to the storage unit 126 are transferred, together with the additional information, to the memory unit 108.

In the process controller 150 of the memory unit 108, the remote copy controller 154 controls the processing unit 152 such that the data temporarily stored in the semiconductor memory 168 is remotely copied to the second server 106. The data temporarily stored in the semiconductor memory 168 are transferred to the second server 106 through the third bus 178, the PCIe I/F 164, the PCI bus 158, the LAN I/F 160 and the LAN 118.

When the data temporarily stored in the semiconductor memory 168 is the difference data, the additional information is also stored in the semiconductor memory 168 by the processing unit 152 of the process controller 150. Thus, the transfer of the difference data may be identified by the additional information, and therefore, the difference data controller 156 of the process controller 150 causes the remote copy controller 134 to control the difference data. The remote copy controller 134 controls the processing unit 152 thereby to transfer the difference data to the second server 106. Specifically, the processing unit 152 transfers the difference data temporarily stored in the semiconductor memory 168 to the storage unit 146 of the second server 106 through the LAN 118. In the process, the additional information is also transferred together with the difference data to the second server 106 as the data to be transferred from the semiconductor memory 168.

In the second server 106, the data transferred thereto is passed through the LAN I/F 140, and after being processed by the processing unit 132 of the process controller 130 and the memory 142 through the second bus 138, stored in the storage unit 146.

When the transferred data is the difference data, the additional information is transferred together with the difference data to the memory 142 by the processing unit 132 of the process controller 130. Since the transfer of the difference data is be identified by the additional information, the difference data controller 136 of the process controller 130 causes the remote copy controller 134 to control the difference data. The remote copy controller 134 causes the processing unit 132 to update only the data which is changed after the previous updating session among the data accumulated in the storage unit 146 and to carry out the mirroring with the data stored in the semiconductor memory 168.

When the data amount requiring copying on the first server 104 is equal to or less than the capacity of the semiconductor memory 168 of the memory unit 108, the storage unit 126 of the first server 104 and the memory unit 108 are in completely mirrored relation with each other.

On the other hand, when the data amount requiring copying on the first server 104 is smaller than the capacity of the semiconductor memory 168, only the information on the update data is handled.

Each time the data to be transferred to the second server 106 is transferred to the storage unit 146, the data stored in the semiconductor memory 168 of the memory unit 108 is erased. Nevertheless, the history of the update information may be held.

With the process described above, a situation rarely occurs in which the backup process required for mirroring is delayed by the consumption of the CPU power due to the frequency access to the first server 104 or the data processing. Further, the mirroring of the server is made possible without holding the access from the clients in standby or consuming the time for processing the client requests.

Therefore, without regarding to the availability of the first server 104, the data of the first server 104 may be backed up in the second server 106 at a remote site.

Further, the data of the first server 104 may be easily backed up physically without any dedicated line for the second server 106 which is disposed at the remote site, and therefore, the cost is reduced.

Further, the services of the first server 104 may not be interrupted.

Further, in view of the mirrored relation between the storage unit 126 of the first server 104 and the semiconductor memory 168 of the memory unit 108, the data is less likely to be lost even when one of the two devices is destroyed or goes out of operation.

Further, the memory unit 108 is located in the vicinity of the first server 104, and therefore, the copying process from the storage unit 126 of the first server 104 is not delayed. Thus, the load on the first server 104 is reduced.

Further, in view of the fact that the data is transferred from the first server 104 to the semiconductor memory 168 (for example, the memory module used for the main memory of the computer) of the memory unit 108 using the high-speed serial transfer interface such as the PCI Express Interface, the fast mirroring is made possible.

Further, the memory unit 108 takes charge of the backup process required for mirroring of the first server 104, and therefore, the process of the first server 104 is distributed, thereby smoothing the transmission between the client and the first server 104.

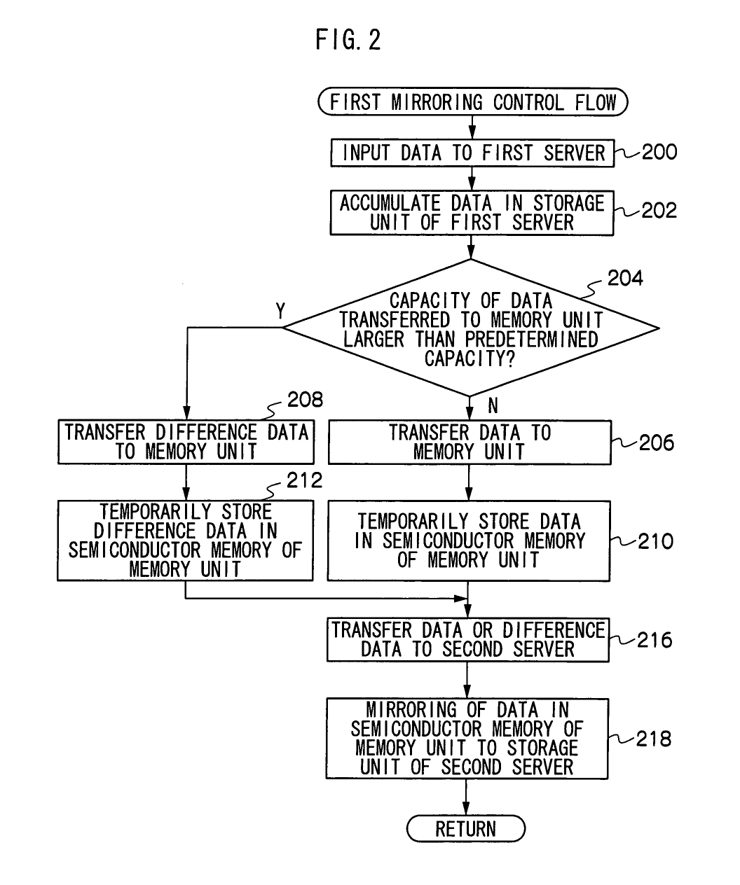

FIG. 2 is a flowchart showing the first mirroring control flow in the information processing system according to the first exemplary embodiment of the invention.

The operation of this exemplary embodiment is explained below.

In step 200, the data is input to the first server 104. Specifically, the data input from the input terminal device 102 is transferred to the first server 104 through the LAN 118.

In step 202, the data is accumulated in the storage unit 126 of the first server 104. Specifically, the data is transferred to the first server 104 through the LAN 118, the LAN I/F 120 and the first bus 128. Next, the data thus transferred is processed on the memory 122 by the processing unit 112 and the remote copy controller 114 of the process controller 110 through the first bus 128, and accumulated in the storage unit 126 of the first server 104 (FIG. 1).

Step 204 determines whether the capacity of the data transferred to the memory unit 108 is larger than a predetermined capacity. Specifically, the capacity of the data to be transferred to the memory unit 108 is compared with the available capacity of the semiconductor memory 168 of the memory unit 108 by the processing unit 112 of the process controller 110 of the first server 104. When as a result of comparison, the capacity of the data to be transferred to the memory unit 108 is not equal to or smaller than the available capacity of the semiconductor memory 168 of the memory unit 108, then the control proceeds to step 206. When the capacity of the data to be transferred to the memory unit 108 is larger than the available capacity of the semiconductor memory 168 of the memory unit 108, on the other hand, the control proceeds to step 208.

In step 206, the data is transferred to the memory unit 108. Specifically, the remote copy controller 114 of the process controller 110 of the first server 104 transmits an instruction to the processing unit 112 to transfer the data to the memory unit 108. The processing unit 112 that has received the instruction transfers the data accumulated in the storage unit 126 of the first server 104 to the memory unit 108 through the first bus 128 and the PCIe I/F 124 (FIG. 1).

On the other hand, when the capacity of the data to be transferred to the memory unit 108 is larger than the available capacity of the semiconductor memory 168 of the memory unit 108, the difference data is transferred to the memory unit 108 in step 208. Specifically, the difference data controller 116 of the process controller 110 issues an instruction to the processing unit 112 through the remote copy controller 114 to transfer the difference data to the memory unit 108. The processing unit 112, in response to the instruction from the difference data controller 116, transfers the difference data of the data accumulated in the storage unit 126 of the first server 104 to the memory unit 108 through the first bus 128 and the PCIe I/F 124. In the process, the processing unit 112 and the difference data controller 116 transfer the additional information and the difference data to be transferred to the memory unit 108 through the first bus 128, the PCIe I/F 124 and the high speed circuit 148 (FIG. 1).

In step 210, the data is temporarily stored in the semiconductor memory 168 of the memory unit 108. Specifically, the processing unit 152 of the process controller 150 of the memory unit 108 causes the remote copy controller 154 to temporarily store the data transferred from the first server 104 in the semiconductor memory 168 through the PCIe I/F 164 and the third bus 178.

In step 212, the difference data is temporarily stored in the semiconductor memory 168 of the memory unit 108. Specifically, the processing unit 152 of the process controller 150 of the memory unit 108 causes the difference data controller 156 to temporarily store the difference data transferred from the first server 104 in the semiconductor memory 168 through the PCIe I/F 164 and the third bus 178. In the process, the processing unit 152 and the difference data controller 156 causes the additional information and the difference data transferred to be stored temporarily in the semiconductor memory 168 of the memory unit 108 through the high-speed line 148, the PCIe I/F 164 and the third bus 178 (FIG. 1).

In step 216, the data or the difference data is transferred to the second server 106. Specifically, the remote copy controller 154 of the process controller 150 of the memory unit 108 transmits an instruction to the processing unit 152 to transfer the data to the second server 106. As an alternative, the difference data controller transmits an instruction to the processing unit 152 through the remote copy controller 154 to transfer the difference data to the second server 106. The processing unit 152, which has received the instruction to transfer the data or the difference data, transfers the data or the difference data including the additional information stored temporarily in the semiconductor memory 168 of the memory unit 108 to the second server 106.

In step 218, the data or the difference data stored temporarily in the semiconductor memory 168 of the memory unit 108 is mirrored to the storage unit 146 of the second server 106. Specifically, the data or the difference data transferred from the semiconductor memory 168 of the memory unit 108 to the second server 106 through the LAN 118 is processed by the processing unit 132, the remote copy controller 134 and the difference data controller 136 of the process controller 130 of the second server 106. The remote copy controller 134 causes the processing unit 132 to process the transferred data in the memory 142 and accumulate (mirror) it in the storage unit 146. As an alternative, the difference data controller 136 causes the processing unit 132 to process the difference data including the additional information transferred thereto through the remote copy controller 134 such that the only the data in the memory 142 which is changed, updated or added after the previous update session is rewritten and the resulting data is mirrored by being reflected in the data of the storage unit 146.

After complete mirroring to the second server 106, the data stored in the semiconductor memory 168 of the memory unit 108 are sequentially deleted by the processing unit 152 of the process controller 150. The history of the update information, however, may be held.

By repeating the aforementioned process, the data in the storage unit 126 of the first server 104 may be ensured to be mirrored to the storage unit 146 of the second server 106 by the memory unit 108 in place of the first server 104.

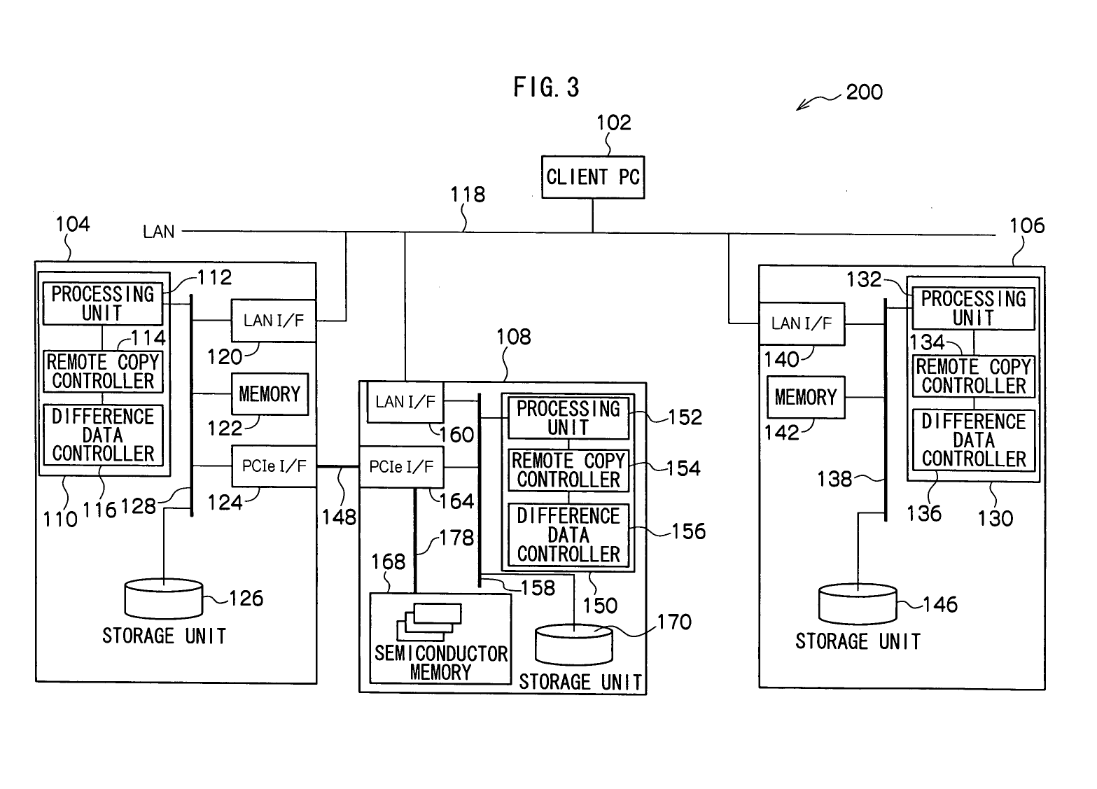

FIG. 3 is a diagram (block diagram) showing a general configuration of the information processing system according a second exemplary embodiment of the invention.

The second exemplary embodiment of FIG. 3 is a modification of FIG. 1, and the general configuration thereof is different only in that the storage unit 170 is connected to the PCI bus 158 of the memory unit 108.

Therefore, the first information processing system (general configuration of the first exemplary embodiment) 100 and the second information processing system (general configuration of the second exemplary embodiment) 200 have the same configuration except for the storage unit 170 according to the second exemplary embodiment.

The processing unit 152, the remote copy controller 154 and the difference data controller 156 of the process controller 150 shown in FIG. 3, however, control the storage unit 170 as well as the semiconductor memory 168 at the same time.

The operation of this exemplary embodiment is explained below.

Only the parts different from the first exemplary embodiment are explained below.

The data transferred from the first server 104 to the memory unit 108 is temporarily stored in the semiconductor memory 168 through the PCIe I/F 164 and the third bus 178. After that, in accordance with the availability of the process controller 150, the data stored in the semiconductor memory 168 is held also in the storage unit 170 through the PCI bus 158 by the processing unit 152 of the process controller 150.

Further, when the capacity of the data to be transferred from the storage unit 126 exceeds the available capacity of the semiconductor memory 168, the processing unit 152 of the process controller 150 temporarily stores only the updated difference data in the semiconductor memory 168. Based on this difference information, the same data as the data stored in the storage unit 126 are reproduced in the storage unit 170.

Then, the remote copy controller 154 of the process controller 150 causes the processing unit 152 to remotely copy the data temporarily stored in the semiconductor memory 168 to the second server 106.

The data temporarily stored in the semiconductor memory 168 is transferred to the second server 106 through the third bus 178, the PCIe I/F 164, the PCI bus 158, the LAN I/F 160 and the LAN 118.

When the data temporarily stored in the semiconductor memory 168 is the difference data, the difference data controller 156 of the process controller 150 causes the processing unit 152 to transfer the difference data to the second server 106. Specifically, the processing unit 152 transfers the difference data temporarily stored in the semiconductor memory 168 to the storage unit 146 of the second server 106 through the LAN 118. In the process, the data to be transferred from the semiconductor memory 168 is transferred to the memory 142 of the second server 106 at the same time as the difference data including the additional information.

Thus, the storage of the data identical with the data stored in the storage unit 126 of the first server 104 is reproduced in the storage unit 146 of the second server 106.

If the storage capacity allows, the data stored in the storage unit kept stored. When the storage unit 170 of the memory unit 108 has the storage capacity equal to or more than the storage unit 126 of the first server 104, the data may be kept stored. The storage unit 170 may take the form of a server on behalf of the second server 106 by continuing to store the data transferred from the first server 104. Further, the difference data transferred from the first server 104 may be changed, updated or added to the data which has been transferred in the previous update session thereby to mirror the data of the storage unit 126 of the first server 104.

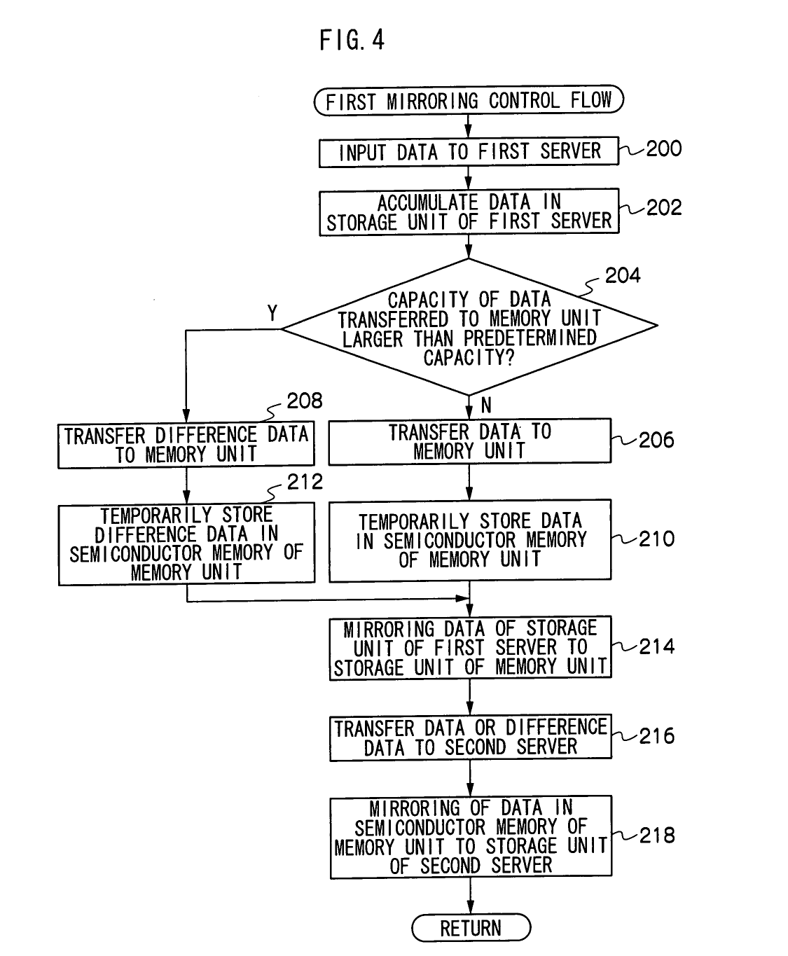

FIG. 4 shows a flowchart for the second mirroring control flow in the information processing system according to the second exemplary embodiment of the invention.

The operation of this exemplary embodiment is explained below, and only the parts different from those of the first exemplary embodiment are explained.

This exemplary embodiment is different from the first exemplary embodiment only in that step 214 is added between step 210, step 212 and step 216.

In step 214, the data of the storage unit 126 of the first server is mirrored to the storage unit 170 of the memory unit 108. Specifically, in steps 210 and 212, based on the data or the difference data including the additional information stored temporarily in the semiconductor memory 168 of the memory unit 108, the data in the storage unit 126 of the first server is held in the storage unit 170 of the memory unit 108. After that, the control proceeds to step 216, and the data held in the storage unit 170 of the memory unit 108 is transferred to the second server 106 through the LAN 118.

As described above, the memory unit 108 has the storage unit 170 other than the semiconductor memory 168. As a result, the data reliability is improved which in turn improves what is called the backup reliability.

The memory unit 108 has the storage unit 170 in addition to the semiconductor memory 168, and therefore, may act on behalf of the first server 104.

Further, the memory unit 108, which is provided with the storage unit 170 in addition to the semiconductor memory 168, has stored therein the same data as the storage unit 126 of the first server. Further, the memory unit 108 has the same function as the first server 104 and the second server 106. Therefore, the memory unit 108 may function on behalf of the first server 104 and the second server 106.

The semiconductor memory 168 is not limited to the DIMM (Dual Inline Memory Module) of the SDRAM (Synchronous DRAM) used in the main memory of the computer, but may be a flash memory or the nonvolatile memory (NVRAM).

The first to third buses of the first server 104, the second server 106 and the memory unit 108 may take any form capable of high-speed parallel transfer.

The dedicated line 148, which is a high-speed serial transfer interface such as PCI Express according to the first and second exemplary embodiments of the invention, may alternatively be a channel such as a fiber channel.

A WAN may be used instead of LAN 118.

In the first and second exemplary embodiments of the invention two servers are used, more than two servers may be connected.

In the first and second exemplary embodiments of the invention only one memory unit 108 is used, more than one memory unit 108 may be disposed.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to are suited to the particular use contemplated. It is intended that the scope of the invention be defined by the following claims and their equivalents.

What is claimed is:

1. An information processing system comprising:
a first server that accumulates data that is input through a network;
a second server that is connected to the network, that is physically disposed at a predetermined distance from the first server and that backs up the data from the first server; and
a memory unit that is connected to the network, that is connected to the first server through a dedicated line in the vicinity of the first server and that temporarily stores backup data to be sent to the second server.

2. The information processing system of claim 1, wherein the backup data temporarily stored in the memory unit is transferred to the second server.

3. The information processing system of claim 1, wherein
when the amount of difference data between the input data and data which has been previously backed up from the first server to the second server is larger than the capacity of the memory unit, the memory unit temporarily stores difference information associated with the difference data and, by transferring the difference information to the second server, the second server backs up the data, and
when the amount of the difference data between the input data and the data which has been previously backed up from the first server to the second server is equal to or smaller than the capacity of the memory unit, the memory unit temporarily stores the input data and, by transferring the input data to the second server, the second server backs up the data.

4. The information processing system of claim 3, wherein the difference information comprises the difference data and additional information indicating the difference data.

5. The information processing system of claim 1, wherein the memory unit comprises a fast access semiconductor memory.

6. The information processing system of claim 5, wherein
the memory unit further comprises a processing unit that transmits/receives the data, and a remote copy controller that provides an instruction to copy the data,
the processing unit causes the semiconductor memory to temporarily store the data when the data is transferred from the first server, and
the remote copy controller instructs the processing unit to transfer the data to the second server, and the processing unit transfers the data stored in the semiconductor memory to the second server.

7. The information processing system of claim 6, wherein
the memory unit further comprises a difference data controller that controls difference data between the input data and data which has been previously backed up from the first server to the second server,
when the amount of difference data is larger than the capacity of the semiconductor memory, the processing unit, upon receipt of difference information associated with the difference data from the first server, temporarily stores the difference information at the semiconductor memory, the difference data controller instructs the remote copy controller through the remote controller to cause the processing unit to transfer the difference information to the second server, and the processing unit transfers the difference information stored in the semiconductor memory to the second server.

8. The information processing system of claim 1, wherein the memory unit comprises a fast access semiconductor memory and a storage unit capable of storing large capacity data.

9. The information processing system of claim 8, wherein the storage unit stores the same data as the data accumulated in the first server.

10. The information processing system of claim 8, wherein
when the amount of difference data between the input data and data which has been previously backed up from the first server to the second server is larger than the capacity of the semiconductor memory, the semiconductor memory temporarily stores difference information associated with the difference data, the storage unit stores the same data as the data accumulated in the first server based on the difference information, and by transferring the difference information to the second server, the second server backs up the data, and
when the amount of the difference data between the input data and the data which has been previously backed up from the first server to the second server is equal to or smaller than the capacity of the memory unit, the semiconductor memory temporarily stores the input data, the storage unit temporarily stores the input data, and, by transferring the data to the second server, the second server backs up the data.

11. The information processing system of claim 1, wherein the network comprises a LAN.

12. The information processing system of claim 1, wherein the network comprises a WAN.

13. The information processing system of claim 1, wherein the dedicated line comprises a fast serial transfer interface.

14. The information processing system of claim 1, wherein the dedicated line comprises PCI Express.

15. The information processing system of claim 1, wherein the dedicated line comprises a fiber channel.

16. An information processing system comprising:
a first server that accumulates data that is input through a network and generates difference information associated with difference data from data which has been already accumulated;
a memory unit that is connected to the network, that is connected to the first server through a dedicated line, and that temporarily stores the difference information and transfers the difference information to a second server; and
the second server that is connected to the network, that receives the difference information from the memory unit and that backs up the data from the first server based on the difference information.

17. The information processing system of claim 16, wherein
when the amount of the difference data is larger than the capacity of the memory unit, the difference information is generated and transferred, and
when the amount of the difference data is equal to or smaller than the capacity of the memory unit, the input data is transferred from the first server to the memory unit and stored in the memory unit, and the input data is transferred from the memory unit to the second server.

18. A method of backing up data, comprising:
accumulating data that is input through a network in a first server;
transferring the data from the first server to a memory unit connected to the first server through a dedicated line and storing the data temporarily; and
transferring the data temporarily stored in the memory unit to a second server connected to the network, thereby backing up the input data.

19. The method of backing up the data of claim 18, further comprising generating difference information associated with difference data when the amount of the difference data between the input data and data which has been previously backed up is larger than the capacity of the memory unit; wherein
the transferring of the data from the first server to the memory unit and the storing of the data temporarily comprises transferring and temporarily storing the difference information; and
the transferring of the data from the memory unit to the second server comprises storing the difference information.
